(19) United States
(12) Patent Application Publication
(10) Pub. No.: US 2026/0179249 A1
(43) Pub. Date: Jun. 25, 2026

(54) METHOD FOR DETERMINING SENSOR POSE BASED ON VISUAL DATA AND NON-VISUAL DATA

(71) Applicant: EXPLORATION ROBOTICS TECHNOLOGIES INC., Piedmont, CA (US)

(72) Inventors: Yaroslav Shchekaturov, Toronto (CA); Oleg Mikhailov, Piedmont, CA (US); Richard Clarke, Houston, TX (US); Aron Cohen, Bayonne, NJ (US)

(21) Appl. No.: 19/126,901

(22) PCT Filed: Nov. 3, 2023
(86) PCT No.: PCT/US2023/036797

§ 371 Date: May 2, 2025

Related U.S. Application Data
(60) Provisional application No. 63/422,043, filed on Nov. 3, 2022.
(60) Provisional application No. 63/529,922, filed on Jul. 31, 2023.

(51) Int. Cl. G06T 7/73; G05D 1/243; G05D 101/10; G05D 111/10; G06T 7/00; G06T 7/50; G06V 10/774; G06V 10/82; G06V 20/50; G06V 20/70

(52) U.S. Cl. CPC G06T 7/73; G05D 1/243; G06T 7/0002; G06T 7/50; G06V 10/774; G06V 10/82; G06V 20/50; G06V 20/70; G05D 2101/10; G05D 2111/10; G06T 2207/20081; G06T 2207/20084; G06T 2207/30244

(57) ABSTRACT

The present disclosure relates to a method for determining position and orientation of a visual sensor and within an environment. The method comprises acquiring a training set of visual data of the environment and an object arranged therein, training an interpolation neural network for estimating one or more synthetic poses using the first set of visual data, and training a convolutional neural network with the first set of visual data. The method comprises acquiring an inspection set of visual data of the environment and an object arranged therein, estimating a coarse pose with the convolutional neural network, and predicting a synthetic image associated with the coarse pose with the interpolation neural network. The method may be performed with data obtained from non-visual sensors.

### CROSS-REFERENCE TO RELATED APPLICATION

The present application claims priority to U.S. Provisional Application No. 63/422,043 (filed Nov. 3, 2022) and U.S. Provisional Application No. 63/529,922 (filed Jul. 31, 2023), both incorporated herein by reference in their entireties for all purposes.

### FIELD

The present disclosure relates to a method for determining the pose of a sensor based on visual data and optionally non-visual types of data.

### BACKGROUND

3D modeling and characterization of various properties of physical objects can be undertaken by processing data obtained by sensors. Typically, visual sensors (e.g., color cameras and IR cameras) obtain a plurality of data points (e.g., RGB values and depth data) from a plurality of different “poses” (i.e., position and orientation in Euclidean space), which are subsequently processed to render a 3D model. Other data (e.g., thermal, acoustic, chemical, etc.) obtained from other sensors can be mapped onto a surface of a 3D model.

3D modeling can accurately characterize individual static scenes or characteristics of a physical object (e.g., characteristics of a surface or manifested on a surface thereof), but accuracy becomes a challenge when comparing temporally distinct (“time-lapse”) data collections. The same applies to panorama image stitching (e.g., Google Maps Street View) in lieu of 3D modelling.

One area in which time-lapse data collections can be employed is autonomous asset inspection and maintenance operations. In this field, data collected at one point or period in time could be compared to data collected at another point or period in time to discern similarities and differences of the characteristics of the object inspected between said points or periods in time. By way of example, a bridge may be inspected over time to determine if any structural anomalies (e.g., physical damage) have developed. Another example is the inspection of a compressor engine to determine if the temperature on its gear box is increasing as the result of deterioration of the shaft alignment. In this regard, time-lapse analysis of characteristics (e.g., characteristics that may include structure, temperature, and/or vibration of an object and surfaces thereof, including characteristics emanating from the object such as fugitive chemical plumes) is a powerful tool for determining asset integrity and operations conditions. However, time-lapse comparisons are currently hampered by lack of accuracy.

One challenge in the accuracy of time-lapse data comparison, whether by 3D modelling or image stitching, is the variation in the pose of sensors. If a sensor is carried by a human, drone or a robot, then the path of the sensors and the orientation of the sensors varies from one inspection to the next as the result of, for example, variations of human walking speed and path, robot's trajectory while avoiding obstacles or drone flight path impacted by the wind conditions. Even sensors adapted to traverse a pre-determined path (e.g., sensors with autonomous motion capabilities) inevitably deviate from said path due to a multitude of factors such as mechanical failures in a locomotive system, ground conditions, weather conditions (e.g., wind for an aerial robot carrying the sensors), path blockages, tolerances inherent in locomotion systems, or the like. As a result, comparison of data captured by a sensor in a first location to data captured by the sensor in a second location reflects, to a relatively larger degree, differences in pose, and to a relatively lesser degree, the difference in properties of a 3D object being inspected. Therefore, analyses of differences in data acquired at different points or periods in time do not accurately reflect actual differences in objects of which data is obtained. In one aspect, if no change has occurred in the actual object, nevertheless a change may be reflected in the time-lapse comparison due to differences in pose. In another aspect if a change has occurred in the actual object, the magnitude of the change characterized by time-lapse comparison may be skewed from the actual magnitude due to differences in pose.

A conventional solution is to provide locomotive adjustments to maneuver the sensors into an intended pose. This can be less efficient, compared to the presently disclosed method, with respect to computing power and the time it takes to reposition said sensor. In some circumstances, repositioning may not be possible (e.g., due to an obstruction).

In regard to sensor repositioning, the sensor typically needs to reference what object it is viewing to determine prior poses associated with the object so the sensor can be repositioned to said poses. Conventional methods typically employ image recognition technologies to determine what object is being viewed, relying at least in part on location tracking data (e.g., global positioning system (GPS), inertial measurement units (IMU), one or more beacons, etc.).

Pose comprises a position component and an orientation component. For many purposes, it may not be sufficient to solely rely on location tracking technologies (e.g., GPS, IMU, beacons, etc.), which only conveys position. While location tracking can ascertain what objects are in proximity to the sensor, if those objects are pre-mapped within an environment, at least one challenge is determining the direction in which the sensor is oriented. By way of example, while two objects may be in proximity to a sensor, one object may be behind the sensor while the sensor is oriented towards the other object.

Another challenge in this field involves accounting for objects moving within an environment. By way of example, it is not uncommon that the configuration of a manufacturing plant or other site is changed from time-to-time. Thus, pre-mapping of objects within an environment and reliance solely on the objects'position on a map (e.g., defined by GPS, beacons, IMU, etc.) to determine the orientation of 3D objects in the environment relative to the sensor does not account for objects that move or rotate relative to a prior position on a pre-developed map.

After a primary inspection is performed, secondary inspections and/or maintenance operations can be performed. In this regard, sensors may be deployed to obtain detailed data regarding points and/or regions of interest flagged from a primary inspection. Moreover, maintenance of objects at the points and/or regions of interest may be performed. In the event that secondary inspections and/or maintenance operations are performed autonomously, precise and accurate pose information is required to ensure that the correct point and/or region of interest is addressed by the secondary inspections and/or maintenance operations.

Yet another challenge in the field is mapping data onto 2D images and/or 3D models. In some circumstances, different types of sensors (e.g., thermal sensors) are employed in tandem with visual sensors. However, the different sensors are typically located at different positions and thus, their viewing axis needs to be aligned to avoid skewed mapping of different types of data onto visual data (e.g., a point cloud). Active methods for calibrating thermal sensors to visual sensors are known. One such method involves observing a checkerboard comprising white and black boxes that has been heated by an external heating source. Thus, the disparate temperatures of the black and white boxes can be detected and aligned with the visual image of the white and black boxes. However, this method is directed to observed objects and sensors that are static relative to each other, in addition to requiring active heating.

Another challenge is the synchronization of the frame rates of the sensors. Since frame rates ultimately depend on immutable hardware settings, un-synced frame rates of different sensors can result in skewed mapping to visual data. This challenge is particularly relevant to sensors and/or observed objects that are in motion. For example, if a visual sensor captures a frame of a scene at a first moment and a thermal sensor captures a frame of a scene at a second moment, and between the first and second moments the sensors are in motion, the visual and thermal data cannot be simply aligned since the frames do not correspond to the same pose. This phenomenon may be termed temporal misalignment.

There is a need to provide precise and accurate time-lapse data comparisons for asset inspections.

There is a need for precise and accurate identification of similarities and/or differences of objects from disparate data sets collected at different points and/or periods in time. There is a need for characterization of similarities and/or differences with measurable values having magnitudes that cooperate with actual values unmolested by variations in sensor pose.

There is a need to address deviations in sensor pose with respect to temporally disparate inspections without relying on repositioning sensors.

There is a need to identify objects observed by sensors without relying on location tracking technologies.

There is a need to identify objects that move and/or rotate within an environment between different instances of data collection.

There is a need to calibrate different types of sensors to visual sensors by passive methods.

There is a need to address temporal misalignment of sensors.

### SUMMARY

The present disclosure provides for a method for determining position and orientation of a visual sensor within an environment, which may address at least some of the needs identified above. The method may comprise acquiring, by the visual sensor, a training set of visual data of the environment and the object. The method may comprise training an interpolation neural network, with the training set of visual data. The method may comprise training a convolutional neural network, with the training set of visual data.

The method may comprise acquiring, by the visual sensor, an inspection set of visual data of the environment and the object. The method may comprise estimating, via the convolutional neural network, the coarse pose of the input image from the inspection set of visual data. The method may comprise predicting, via the interpolation neural network, from the coarse pose, a synthetic image associated with the coarse pose. The method may comprise refining the coarse pose, by minimizing the difference between the synthetic image and the input image, to obtain a fine pose of the input image.

The training set of visual data may comprise genuine 2D images derived from the visual sensor; 2D images obtained from a Computer-Assisted Design 3D model; a photogrammetry-derived 3D model; a LIDAR-point-cloud-derived 3D model; a 3D model derived from any combination of Computer-Assisted Design, photogrammetry, and a LIDAR point cloud; or any combination thereof.

The training set of visual data may be semantically segmented by a human and/or a neural network prior to training the convolutional neural network and/or the interpolation neural network. Semantic segmentation may be performed in order to establish ground truths that can be compared to an output of the convolutional neural network and/or an output of the interpolation neural network such that weights applied by the convolutional neural network and/or the interpolation neural network can be adjusted. The foregoing may be applicable to all embodiments.

A plurality of color textures may be applied to the Computer-Assisted Design 3D model, the photogrammetry-derived 3D model; the LIDAR-point-cloud-derived 3D model; the 3D model derived from any combination of Computer-Assisted Design, photogrammetry, and the LIDAR point cloud; or any combination thereof. The 2D images may be obtained therefrom with each of the plurality of color textures. The foregoing may be applicable to all embodiments.

The weights applied by the convolutional neural network and/or the interpolation neural network may be biased in favor of geometry over color. The foregoing may be applicable to all embodiments.

The weights applied by the convolutional neural network and/or the interpolation neural network may consider depth data. The weights applied by the convolutional neural network and/or the interpolation neural network may ignore color. The foregoing may be applicable to all embodiments.

The convolutional neural network may employ a Differentiable Sample Consensus (DSAC) algorithm.

The DSAC algorithm may be modified by the use of a parametric rectified linear unit (“PReLU”) activation function.

The interpolation neural network may be a neural radiance field, a predictive linear optimization algorithm, or a predictive non-linear optimization algorithm. The interpolation neural network may be a neural radiance field.

The interpolation neural network may be depth-supervised.

The training set of visual data and the inspection set of visual data may be acquired by two or more visual sensors in the form of a stereo camera or a multi-lens camera.

An inverted neural radiance field may be employed for refining the coarse poses.

The method may further comprise removing, as an outlier, the synthetic image if the synthetic image differs from the input image by a threshold.

The method may further comprise comparing time-lapse data by comparing the input image from the inspection set of visual data with a second input image from a second inspection set of visual data. The second inspection set of visual data may be acquired prior-in-time to the inspection set of visual data.

If the fine pose of the input image does not correspond to the fine pose of the second input image, the method may comprise obtaining the fine pose of the input image or a fine pose of the second input image; predicting, via the NeRF neural network, from the fine pose of the input image or the fine pose of the second input image, a synthetic image; and comparing the synthetic image to the input image or the second input image, whichever is not associated with the fine pose with which the synthetic image was predicted.

The method may comprise localizing a robotic element, including moving a robot comprising the visual sensor and the robotic element to the object or the general area thereof; and moving the robot toward a point of interest and/or a region of interest on the object. The method may comprise acquiring, by the visual sensor, an image of the point of interest and/or the region of interest; estimating, via the convolutional neural network, the coarse pose of the image of the point of interest and/or the region of interest; predicting, via the interpolation neural network, from the coarse pose, a synthetic image associated with the coarse pose; refining the coarse pose, by minimizing the difference between the synthetic image and the image of the point of interest and/or the region of interest, to obtain a fine pose of the image; determining the pose of the robotic element by feedback from one or more position sensors; relating the fine pose of the image to the determined pose of the robotic element; and repositioning the pose of the robotic element until it cooperates with the fine pose of the image. The foregoing may be applicable to all embodiments.

The robot may be moved to the object or the general area thereof by a human operator piloting the robot; re-tracing a path traversed during acquisition of the inspection set of visual data and stopping at a location corresponding to a time-stamp of the input image; reference to a 3D model; location tracking technology; or any combination thereof. The foregoing may be applicable to all embodiments.

The method may comprise localizing a human-held element comprising the visual sensor, including: acquiring, by the visual sensor, an image of the environment; estimating, via the convolutional neural network, the coarse pose of the image of the environment; predicting, via the interpolation neural network, from the coarse pose, a synthetic image associated with the coarse pose; refining the coarse pose, by minimizing the difference between the synthetic image and the image of the point of interest and/or the region of interest, to obtain a fine pose of the image; relating the fine pose of the image to a location of an object of interest; and guiding a human operator holding the human-held element to the object of interest. The foregoing may be applicable to all embodiments.

The method may comprise identifying the object. The object may be identified by providing the input image to the trained convolutional neural network. The object may be identified by cross-referencing the fine pose to a prefabricated map and/or a 3D model of the environment. The object may be identified by cross-referencing a time stamp of the input image to the path defined on a prefabricated map and/or a 3D model of the environment. The object may be identified by tracking a location of the visual sensor. The foregoing may be applicable to all embodiments.

The method may further comprise training a second convolutional neural network with the training set of visual data; and semantically segmenting the input image from the inspection set of visual data. The foregoing may be applicable to all embodiments.

The present disclosure provides for a method for determining position and orientation of a visual sensor and a non-visual (e.g., a chemical sensor and/or a thermal sensor) within an environment, which may address at least some of the needs identified above.

The method may comprise acquiring, by the visual sensor and the non-visual sensor, a training set of visual data and a training set of non-visual data of the environment and the object. The method may comprise training an interpolation neural network, with the training set of visual data and the training set of non-visual data. The method may comprise training a first convolutional neural network and a second convolutional network, with the training set of visual data and the training set of non-visual data.

The method may comprise acquiring, by the visual sensor and the non-visual sensor, an inspection set of visual data, comprising an input visual image, and an inspection set of non-visual data, comprising an input non-visual image, of the environment and the object. The method may comprise estimating, via the first convolutional neural network, the coarse pose of the input visual image. The coarse pose of the non-visual input image may be assumed equal to the coarse pose of the input visual image. The method may comprise semantically segmenting, via the second convolutional neural network, features of the visual input image and the non-visual input image. The method may comprise predicting, via the interpolation neural network, from the coarse poses, a synthetic visual image and a synthetic non-visual image associated with the coarse poses. The method may comprise refining the coarse pose of the input visual image, by minimizing the difference between the synthetic visual image and the input visual image, to obtain a fine pose of the input visual image. The method may comprise calibrating the input non-visual image to the input visual image by adjusting the coarse pose of the input non-visual image until the features thereof align.

The non-visual sensor may be a single-spectral electromagnetic sensor (e.g., an infrared thermal sensor), a multi-spectral electromagnetic sensor, an acoustic sensor, a chemical sensor, or any combination thereof.

The visual image may comprise RGB and/or depth data for each pixel. The foregoing may be applicable to all embodiments.

The non-visual image may comprise electromagnetic measurements, acoustic measurements, chemical measurements, or any combination thereof, for each pixel. The electromagnetic measurements are associated with one or more spectra other than the visual spectrum.

The non-visual sensor may be a thermal sensor, the training set of non-visual data may be a training set of thermal data, the inspection set of non-visual data may be an inspection set of thermal data, the input non-visual image may be an input thermal image, and the synthetic non-visual image may be a synthetic thermal image.

The interpolation neural network may comprise a head for predicting the synthetic visual image and a head for predicting the synthetic non-visual image.

The interpolation neural network may estimate depth data for each pixel in the input visual image. The foregoing may be applicable to all embodiments.

The training set of visual data may comprise genuine 2D images derived from the visual sensor; 2D images obtained from a Computer-Assisted Design 3D model; a photogrammetry-derived 3D model; a LIDAR-point-cloud-derived 3D model; a 3D model derived from any combination of Computer-Assisted Design, photogrammetry, and a LIDAR point cloud; or any combination thereof. The training set of non-visual data may comprise genuine 2D images derived from the non-visual sensor.

The training set of visual data and the training set of non-visual data may be semantically segmented by a human and/or the second convolutional neural network prior to training the first convolutional neural network and/or the interpolation neural network. Semantic segmentation may be performed in order to establish ground truths that can be compared to an output of the first convolutional neural network and/or an output of the interpolation neural network such that weights applied by the first convolutional neural network and/or the interpolation neural network can be adjusted.

The first convolutional neural network may employ a Differentiable Sample Consensus (DSAC) algorithm. The DSAC algorithm may be modified by the use of a parametric rectified linear unit (“PRELU”) activation function.

The interpolation neural network may be a neural radiance field, a predictive linear optimization algorithm, or a predictive non-linear optimization algorithm. The interpolation neural network may be a neural radiance field.

The interpolation neural network may be depth-supervised.

The training set of visual data and the inspection set of visual data may be acquired by two or more visual sensors in the form of a stereo camera or a multi-lens camera.

An inverted neural radiance field may be employed for refining the coarse poses.

The method may further comprise removing, as an outlier, the synthetic visual image and/or the synthetic non-visual image if the synthetic visual image differs from the input visual image by a threshold and/or the synthetic non-visual image differs from the input non-visual image by a threshold.

The method may further comprise comparing time-lapse data by comparing: the input visual image with a second input visual image from a second inspection set of visual data; and/or the input non-visual image with a second input non-visual image from a second inspection set of non-visual data. The second inspection set of visual data may be acquired prior-in-time to the inspection set of visual data. The second inspection set of non-visual data may be acquired prior-in-time to the inspection set of non-visual data.

If the fine pose of the input visual image does not correspond to the fine pose of the second input visual image and/or the fine pose of the input non-visual image does not correspond to the fine pose of the second input non-visual image, the method comprises: obtaining the fine pose of the input visual or non-visual image, or a fine pose of the second input visual or non-visual image; predicting, via the interpolation neural network, from the fine pose of the input visual or non-visual image, or the fine pose of the second input visual or non-visual image, a synthetic image; and comparing the synthetic image to the input image or the second input image, whichever is not associated with the fine pose with which the synthetic image was predicted.

The present teachings provide for a non-transitory storage medium comprising computer-readable instructions for performing the method according to any one of the steps described above.

The present teachings provide for an inspection apparatus for use in the method according to any one of the steps described above. The inspection apparatus may comprise: a plurality of sensors including: one or more visual sensors (preferably including at least a stereo camera), one or more location modules (preferably including at least a GPS module), one or more anemometers (preferably including at least a hot wire anemometer), one or more open air optical path gas sensors (preferably including at least a tunable diode laser), one or more thermographic cameras, and one or more microphones; one or more first processors adapted to execute computer-readable instructions for performing the method according to any one of the steps described above; one or more non-transitory storage media adapted to store the computer-readable instructions; or any combination thereof. At least some of the plurality of sensors may each have a central observation axis. The central observation axes may be aligned in parallel. The one or more first processors may be adapted for wired and/or wireless communication with one or more second processors located remote from the inspection apparatus.

The inspection apparatus may further include one or more of the following features: a housing containing the plurality of sensors; one or more grips extending from or formed in the housing; and a spacing between the plurality of sensors of about 9 cm or less, 8 cm or less, 7 cm or less, 6 cm or less, 5 cm or less, 4 cm or less, 3 cm or less, 2 cm or less, or even 1 cm or less; the tunable diode laser being capable of detecting a fluid (e.g., a gas, preferably a hydrocarbon such as a methane), having a sensitivity of 5 ppm-m, having a telemetry distance of at least about 100 m, having a working temperature of about −20° C. or more, having a response speed of about 1 s or less (more preferably about 0.1 s or less), or any combination thereof; and the hot wire anemometer being capable of measuring air velocity, being capable of measuring air temperature, being capable of calculating airflow in unit volume per time, having a probe that extends from the inspection apparatus no more than 10 cm (more preferably no more than 8 cm, more preferably no more than 6 cm, or even more preferably no more than 4 cm), or any combination thereof.

### BRIEF DESCRIPTION OF THE DRAWINGS

FIG. 1 is a diagram of a genuine sensor and a synthetic sensor relative to a 3D object.

FIG. 2 is a diagram of time-lapse data comparison.

FIG. 3 is a flowchart of the present method.

FIG. 4 illustrates the architecture of the convolutional neural network employed by the present teachings.

FIG. 5 illustrates the architecture of the interpolation neural network employed by the present teachings.

FIG. 6A illustrates an inspection apparatus according to the present teachings.

FIG. 6B illustrates an inspection apparatus according to the present teachings.

FIG. 6C illustrates an inspection apparatus according to the present teachings.

### DETAILED DESCRIPTION

### Introduction

The present disclosure provides for a method for determining a position and/or an orientation (“pose”) of a sensor (e.g., a visual sensor) within an environment or site. The environment may have one or more three-dimensional objects (“3D objects” or “objects”) arranged therein. The 3D objects may include one or more surfaces. The determination of the position and/or the orientation of a sensor relative to a 3D object may be advantageous in generating 2D images and/or 3D models and accurately comparing different 2D images and/or 3D models generated from data acquired at different points and/or periods in time. Data acquired at different points and/or periods in time may be referred to herein as time-lapse data or temporally distinct data. Each point and/or period in time may be characterized by discrete inspection events defined by a specific time and/or date (e.g., a morning and evening inspection, a first day and second day inspection, and so on).

The present method may obviate the need for repositioning sensors to cooperate with poses associated with data collected prior-in-time (i.e., intended poses). The present method may determine the pose of a sensor when data is captured so that the data set can be supplemented with synthetic images from synthetic poses to cooperate with an intended pose rather than adjusting the physical pose of the sensors to cooperate with the intended pose. That is, the present method can recreate, from one or more images captured from a second pose (obtained at a second point/period in time), what the image would have looked like from a first pose (obtained at a first point/period in time, which is earlier than the second point/period in time). The present method may create a precise and accurate approximation to the image from the first pose from one or more images acquired at a different point and/or period in time with different poses that are different from the first pose.

The present method contemplates that the pose of one or more visual sensors can be employed to determine the pose of any other sensors. This includes sensors in fixed relationship with the visual sensor and sensors that move relative to the visual sensor. Typically, one or more visual sensors serve to determine the pose of other sensors as visual sensors provide comparatively greater detail relative to other types of sensors employed by the present method (e.g., thermal sensors, acoustic sensors, chemical sensors, etc.). However, the present teachings do not foreclose other sensors being employed to determine pose.

The present method may account for what a sensor (e.g., a visual sensor) should be seeing based on its intended pose from what the sensor (e.g., visual sensor) actually observes based on its actual pose. To this end, the present method may employ an interpolation algorithm, operable with a neural network, to produce “synthetic” images from poses that are not present in the input set of images. To this end, the present method may employ an interpolation neural network. The interpolation neural network may include a NeRF (Neural Radiance Field), neural networks derivative from a NeRF neural network, a predictive linear optimization algorithm, a predictive non-linear optimization algorithm, or any other suitable neural network. The interpolation neural network may construct new data from known data provided in the form of a training data set described herein. The neural network may be taught with a finite set of input images, the data of which may include a 3D location (X, Y, Z) and a 3D viewing direction (φ, θ, Y), and optionally radiance (R, G, B) and volume density (σ) (although via the present method, radiance and volume density may be learned during training of the interpolation algorithm). The radiance may be defined by one or more bands on the electromagnetic spectrum (e.g., visual, infrared, ultraviolet, or multi-spectra bands). Thus, if the input image set does not include an image from an intended pose, the intended pose may be accounted for, and a synthetic image from the intended pose may be produced.

The term “images,” as it relates to non-visual sensors may be used herein understanding that measurements may be translated into a visual medium, such as discussed relative to thermal data herein (e.g., in the form of heat maps). Also, said measurements may be projected onto one or more surfaces of a digital 3D model and/or stitched images. In this regard, the term “images” may be used interchangeably herein with “measurements.”

The present method may apply the interpolation algorithm, described above, developed for the visual images, to any other sensor data to obtain synthetic images or measurements for those sensors for poses that are not present in the input image set of those sensors.

The present method may employ an interpolation neural network (e.g., NeRF) in a unique and unconventional manner. That is, interpolation neural networks are conventionally applied to obtain high-resolution, photo-realistic digital models of static scenes by synthesizing images from an input image set. The present method may determine the actual pose of a visual sensor. The present method may determine the quantitative difference between an intended pose and the actual pose. The pose of any other sensors can be adjusted accordingly.

Moreover, interpolation neural networks are not conventionally employed to determine a pose from an image. Rather, a pose must be provided as an input to an interpolation neural network in order for a synthetic image to be predicted.

In this regard, the present teachings may be advantageous for the interpolation of poses of current inspection data for comparison against poses of past inspection data, determining any gaps in poses of current inspection data, and as described herein, generating synthetic data for gap filling any current inspection data for which there is no corresponding pose to past inspection data. In this way, 1 -to-1 comparisons may be made of data from the same pose.

The present method may include performing other operations based upon the determined pose such as time-lapse data comparisons and robotic interactions with the physical environment.

Pre-modelling may not be necessary for the present method. Rather, image stitching may be performed in lieu of building a model. Pose determination and the generation of synthetic images from synthetic poses may provide for a precise and accurate image stitching.

The present method may identify objects being observed by sensors. The present method may be more robust than object identification methods relying on location tracking technologies. The present method may correlate one or more images with one or more other images having a corresponding pose within an environment. Thus, the present method may be employed in GPS-restricted areas as pose may be gleaned from images rather than location tracking data. Furthermore, the ability of the present method to operate without relying on location data may obviate challenges in the accuracy of these technologies. Such challenges may include interrupted communication with GPS stations, presence of structures that reflect satellite signals, and inherent accuracy limitations of location tracking technologies (e.g., GPS may deviate anywhere within approximately a 30-meter, 25-meter, 20-meter, or even 15-meter radius from a GPS module's true position).

The present method may include robotic interactions with the physical world. That is, robotic elements (e.g., robotic arms), sensors, diagnostic equipment, tools, or any combination thereof may be autonomously articulated with respect to the object being inspected. During maintenance operations following inspections, robotic elements (e.g., robotic arms) may physically interact with objects. To enable precise interaction of robotic elements with points and/or regions of interest, the pose of sensors guiding the robotic elements relative to points and/or regions of interest on the object may be determined. The location of robotic elements may be determined based on the determined pose of the sensors.

The present disclosure may refer to the position and the orientation of a sensor, individually or in combination, as a pose. The position may refer to a position of a sensor in Euclidean space defined by, e.g., X, Y, and Z axes. The orientation may refer to the line-of-sight of a sensor and may be expressed as an angle (roll, pitch, yaw).

Pose may be determined by the present method to generate synthetic images from synthetic poses. In this regard, synthetic images generated from synthetic poses can be accurately compared to genuine images.

Comparison of time-lapse data discussed herein may be undertaken to inspect assets. The assets may be man-made and/or manufactured objects, man-made and/or manufactured structures, natural structures (e.g., terrain), living beings (e.g., humans, animals, or plant life), or any combination thereof. Assets may also be referred to herein as 3D objects or objects. Exemplary assets may include, but are not limited to, industrial equipment (e.g., generators), infrastructure (e.g., bridges), facilities (e.g., commercial, or residential buildings), the like, or any combination thereof.

By such comparison, changes in the assets over time may be identified and if necessary, addressed with in-person and/or autonomous inspection, monitoring, preventative maintenance, repairs, or any combination thereof.

The method of the present disclosure may relate to time-lapse comparisons of one or more different types of data. The data may be defined by one or more bands on the electromagnetic spectrum, sound waves, molecular presence and/or concentration, or any combination thereof. The data may include, but is not limited to, visual data (including one or more points in physical space, color, and illuminance), thermal data, other electromagnetic data, acoustic data, chemical data, the like, or any combination thereof.

The method may employ at least visual data to generate one or more digital 3D models (also referred to herein as 3D models), digital 2D images (also referred to herein as 2D images), or both. The 2D images may be stitched together. The other types of data (e.g., other electromagnetic data like thermal data, acoustic data, chemical data such as atmospheric concentration, etc.) may be mapped onto 3D models, 2D images, or both. By way of example, thermal data captured by thermographic (e.g., infrared) cameras is typically visually communicated by a color palette and shades of the colors thereof representing the physical quantity of temperature (commonly referred to as a heat map), which can be applied as a texture onto a 3D model and/or 2D image. The present teachings contemplate that the heat map may be employed for other types of sensor data such as concentration determined by a chemical sensor and/or sound intensity from an acoustic sensor.

Moreover, the method of the present disclosure may relate to high-detailed time-lapse comparison. High-detailed, as referred to herein, may mean that while images from a second data set may not be taken from exactly the same pose as a first data set, synthetic images can be derived from the second data set such that the pose of synthetic images match (by at least 99%, more preferably at least 99.5%, or even more preferably at least 99.9%) the pose of genuine images of the first data set.

Thus, 2D images and/or 3D models of time-lapse data may be compared directly. Moreover, 2D images and/or 3D models may be mapped with different types of data. Different textures may be selectively applied to and removed from the 2D images and/or 3D models. In this regard, users may toggle between views of different types of data mapped onto the 2D image and/or 3D model on a graphical user interface.

Providing a method for high-detail time-lapse comparison may be relevant in the field of asset inspection, understanding that even a small defect in an asset can be indicative of a failure with implications in asset maintenance and workplace safety. By way of example, a crack measuring 1 cm in length, formed in a pipe carrying natural gas carries the risk of contributing to the ignition of any natural gas leaking via the crack. If a difference in pose of compared 2D images or 3D models obfuscates small defects (e.g., a 1 cm long crack), then costly or dangerous situations may arise. In another aspect, if the magnitude of differences in measurable quantities identified by time-lapse comparison is exaggerated by differences in pose, then follow-up actions may be unnecessarily ordered.

Conventional inspections performed manually, while being time-consuming, allows inspection personnel to view assets up-close. Thus, for autonomous methods described herein to meet or even surpass the integrity of in-person, manual inspections, high-detail time-lapse comparison should be provided for.

The method of the present disclosure may relate to autonomous inspections. That is, one or more steps in data acquisition and/or subsequent processing methodology may be performed without human instruction and/or interaction.

The method of the present disclosure may relate to mobile inspections, whereby sensors move throughout an environment to acquire data of the environment and/or one or more objects situated therein. Moreover, it is contemplated that in addition to sensor movement, objects may move and/or rotate within the environment.

The sensors may be affixed to one or more air-mobile robots, affixed to one or more ground-mobile robots, human-held, or any combination thereof. The robots may be piloted and/or data may be acquired with and/or without human interaction. The robots and/or humans may traverse a path throughout an environment. The location of sensors on the path may be referred to herein synonymously with the position component of the pose. While on the path, one or more sensors may orient in one or more orientations (roll, pitch, yaw). The path and/or orientation may be pre-determined and/or manually directed by human piloting.

Handheld devices equipped with sensors may be particularly advantageous for addressing cost and in some cases, inspection speed. While robots described herein may be advantageous in some adverse environments and for accessing locations otherwise inaccessible or difficult to access for humans, these robotic systems can be costly, and the cost may even surpass human inspector salaries. Moreover, some locomotion means may remain slower than humans.

It has surprisingly been found that the system and method described herein can be employed by inspectors of intermediate (about 25-200 individual inspection events worth of experience) or even novice skill levels (about 1-24 individual inspection events worth of experience). Conventional systems and methods typically benefit from high skill levels in order to adequately locate anomalies in assets such as damage, fugitive gasses, or the like. It has been observed, in conventional systems and methods, that correct and complete location of anomalies diminishes as skill level diminishes. However, by the system and method described herein, a unique and unconventional analysis is set forth whereby pose estimation provides for accurate 3D modelling and/or image stitching-with one or more textures of non-visual data- and any anomalies present may be localized.

One or more sensors may acquire data at one or more locations on the path. Activation (i.e., causing the sensors to acquire data) or de-activation of the sensors (i.e., causing the sensors to stop acquiring data) at one or more locations on the path may be pre-determined and/or manually directed by a human operator. One or more sensors may be active throughout the entirety of the path, or at least one or more discrete locations or lengths thereof. The present disclosure contemplates that data may not be obtained along the entirety of a path in the interest of managing data set sizes, power consumption of sensors, and the like. Sensors may not be activated while travelling in between objects of which observation is intended.

Typically, data may be acquired at one or more discrete locations and/or lengths on a path. Ideally, time-lapse data of an asset may be acquired from the same pose at a first point or period in time and a second point or period in time such that comparison of data is direct. However, the present disclosure contemplates that this may not be possible due to various factors such as mechanical failures in a locomotive system, ground conditions, weather conditions, path blockages, tolerances inherent in locomotive systems, asynchronous frame rates, the like, or any combination thereof.

Autonomous asset inspection described herein may include digitally conveying, to human operators, similarities and differences in time-lapse data on a visual medium (e.g., a digital display device). The present disclosure contemplates that comparing two genuine 2D images and/or 3D models generated from data acquired from different sensor poses may result in a comparison that conveys a lesser or greater magnitude of differences in the time-lapse data relative to a comparison of two genuine 2D images and/or 3D models generated from data acquired from the same sensor pose. Thus, the present teachings provide for a method that employs synthetic poses.

In view of the description above, the present disclosure presents a unique and unconventional method for conducting a time-lapse comparison. The method may include the generation of synthetic 2D images from synthetic poses. The synthetic 2D images may be derived from neural networks trained by genuine 2D images and/or 3D models. The 3D models may be rendered from genuine 2D images or constructed by computer-assisted design software.

Genuine, as referred to herein, may mean 2D images and/or 3D models that are generated directly from data acquired by one or more sensors. Synthetic, as referred to herein, may mean 2D images and/or 3D models that are interpolated by a neural network. In other words, synthetic 2D images and/or 3D models may not be direct reproductions of data captured by one or more sensors.

In this regard, where genuine data from a particular pose is not available, synthetic data from said pose may be generated for time-lapse comparison with the genuine data.

The present disclosure presents a unique and unconventional method for constructing 3D models and/or stitching 2D images. In this regard, textures of non-visual data may be accurately localized on one or more surfaces in the 3D model and/or image.

### System

The method may be at least partially embodied by computer-executable instructions. The computer-executable instructions may be stored on a non-transient storage medium. The method may be carried out by one or more processors. The non-transient storage medium and/or one or more processors may be local to one or more computing devices, sensors, robots, hubs within which the robot resides between inspection events, or any combination thereof. One or more wired and/or wireless data connections may be between the one or more computing devices, sensors, robots, hubs, or any combination thereof.

The method described herein may be performed by the inspection apparatus herein and/or one or more computing devices remote from the inspection apparatus. One or more of the method steps described herein may be distributed between processors of the inspection apparatus and/or the one or more computing devices. The method described herein may be stored as computer-executable instructions on non-transient storage media local to the inspection apparatus and/or remote from the inspection apparatus. In this regard, data may or may not undergo one or more transformations prior to communication (e.g., via a wired and/or wireless communication) to a device remote from the inspection apparatus. In some aspects, the size of the data may be reduced prior to communicating the data from the inspection apparatus. The foregoing may be advantageous for managing network limitations, reducing processing and/or data transmission times, or both.

The system may comprise one or more sensors. The sensors may function to acquire data. The sensors may interact with the physical world and transform said interaction into an output such as an electrical signal. By way of example, photons interact with a charge-coupled device found in a conventional camera. The sensors may include one or more electromagnetic sensors (e.g., visual sensors or thermal sensors), acoustic sensors, chemical sensors, the like, or any combination thereof. The electromagnetic sensors may include single-spectral electromagnetic sensors, multi-spectral electromagnetic sensors, or both. At least one or more visual sensors may be employed in the method of the present teachings. Optionally, one or more other types of sensors may be employed in addition to the one or more visual sensors. Multiple of the same type of sensor may be employed. Multiple of the same type of sensor may be affixed to the same robot.

The method may be performed, at least in part, by an inspection apparatus. An exemplary inspection apparatus is described in US Provisional Application No. 63/529,922, incorporated herein by reference in its entirety. The inspection apparatus may be handheld (e.g., held by a human), integrated into an autonomous robot, or both. The autonomous robot may function to move the inspection apparatus (including a plurality of sensors) throughout an environment. The autonomous robot may be capable of locomotion. The autonomous robot may be ground-mobile, air-mobile, or both. The inspection apparatus may comprise a plurality of sensors. The plurality of sensors may obtain the data described herein.

The inspection apparatus may comprise a housing having the plurality of sensors. The housing may comprise a forward face and a rearward face. The plurality of sensors may be located at least at the forward face. The forward face may be aimed at objects being inspected. The rearward face may comprise a graphical user interface. The graphical user interface may display information for the user.

The inspection apparatus may comprise one or more grips. The grips may function for a user to hold and/or manipulate the inspection apparatus. The grips may be located on the top, bottom, and/or sides of the housing.

One or more sensors may be affixed to one or more pan and tilt platforms. The pan and tilt platforms may be affixed to one or more robots. The pan and tilt platforms may function to provide for panning and tilting relative to a robot on which the one or more sensors.

The method described herein may be performed local to the sensor, a robot on which the visual sensor and/or any other sensors are located, a hub within which the robot resides between inspection events, or any combination thereof.

The plurality of sensors may be located proximate to each other on the inspection apparatus. The plurality of sensors may have a positional offset (spacing) of about 9 cm or less, 8 cm or less, 7 cm or less, 6 cm or less, 5 cm or less, 4 cm or less, 3 cm or less, 2 cm or less, or even 1 cm or less. It may be appreciated by the present teachings that anemometers may not be limited in positional offset to the other sensors as wind speed and/or direction can be determined without correlation to the observation axes of the other sensors described herein. At least some of the plurality of sensors may have central observation axes. The central observation axes may be aligned in parallel.

The plurality of sensors may include one or more visual sensors. The visual sensor may function to convey electromagnetic radiation in the visual spectrum (e.g., about 400 nm to 700 nm) into an image. The visual sensor may include one or more complimentary metal-oxide-semiconductor (“CMOS”) image sensors, charge-coupled device (“CCD”) sensors, the like, or any combination thereof. The visual sensor may be a stereo camera and/or operate in cooperation with laser imaging, detection, and ranging (“LIDAR”). In this regard, depth may be observed by the one or more visual sensors. The visual sensor may generate high resolution images. As referred to herein, high resolution may mean about 10 megapixels (“MP”) to 50 MP (e.g., about 12 MP or more, 15 MP or more, 20 MP or more, 30 MP or more, or even 40 MP or more). One example of a suitable visual sensor may include the Raspberry Pi High Quality Camera, commercially available from Raspberry Pi Ltd.

The plurality of sensors may include one or more location modules. The location module may function to define a location of the inspection apparatus and for correlation of the location to data obtained at that location. The location module may function with one or more satellite-based location services (e.g., the Global Positioning System (“GPS”)). The location module may comprise a receiver (e.g., antenna), a microcontroller, or both. The location module may receive signals (e.g., radio signals) that triangulate the location module relative to three or more satellites (or cell towers for cellular navigation, which is within the scope of the present teachings). The location module may express location on a coordinate system such as latitude and longitude, and optionally altitude.

The plurality of sensors may include one or more chemical sensors. The chemical sensor may include an open air optical path gas sensor (“open path gas sensor”). The open path gas sensor may function to convey electromagnetic radiation into an image, determine presence/absence of a target gas, and optionally determine concentration of the target gas. The open path gas sensor may emit a beam of electromagnetic radiation into the environment (as opposed to an enclosed measurement cell). The open path gas sensor may comprise an emitter that emits electromagnetic radiation and a receiver that receives electromagnetic radiation that is reflected. The electromagnetic radiation may travel through a target gas (e.g., a fugitive plume) and may be reflected by a solid object, such as an object from which the target gas escapes. The emitted electromagnetic radiation may be at least partially absorbed by target gas molecules in narrow bands associated with specific wavelengths and exhibit generally no absorption outside of these bands. A target gas may absorb electromagnetic radiation in characteristic wavelength bands. In this regard, the receiver may obtain attenuated electromagnetic radiation according to the Lambert-Beer relation and thereby identify the target gas and/or the concentration thereof by way of characteristic absorption patterns.

The open path gas sensor may perform wavelength-modulated laser absorption spectroscopy (preferably tunable diode laser absorption spectroscopy). The open path gas sensor may employ a tunable wavelength-modulated diode laser as a light source. The wavelength of the laser may sweep between a non-absorption band and one or more particular absorption bands of a target gas. When the wavelength is tuned outside of the narrow characteristic absorption band (“off-line”), the received light is equal to or greater than when it falls within the narrow absorption band (“on-line”). Measurement of the relative amplitudes of off-line to on-line reception yields a measure of the concentration of the methane gas along the path transited by the laser beam. One example of a suitable tunable diode laser that may be employed in the present teachings is the model S350-W2, commercially available from Henan Zhongan Electronic Detection Technology Co., Ltd.

An example of a tunable diode laser may have some combination of the following characteristics: capable of detecting a fluid (e.g., a gas, preferably a hydrocarbon such as a methane), having a sensitivity of 5 ppm-m, having a telemetry distance of at least about 100 m, having a working temperature of about −20° C. or more, and having a response speed of about 1 s or less (more preferably about 0.1 s or less).

The tunable diode laser may be advantageous to characterize the concentrations of gasses that are presently of concern for their contribution to climate damage (e.g., hydrocarbons such as methane). In this regard, by the system and method described herein, leaks may be identified and rectified to mitigate or even prevent fugitive plumes from escaping into the atmosphere.

The plurality of sensors may include one or more anemometers. The anemometer may function to convey its interaction with wind into a signal. In some aspects, the signal may be analog. The inspection apparatus may comprise an analog-to-digital converter for converting the analog signal into a digital format. The anemometer may determine wind speed, wind direction, or both. The anemometer may be any suitable type of anemometer including hot-wire anemometers, ultrasonic anemometers, acoustic resonance anemometers, or any combination thereof. Preferably, the plurality of sensors include a hot-wire anemometer (e.g., constant current anemometers, constant voltage anemometers, constant temperature anemometers, and pulse-width modulation anemometers; preferably a constant temperature anemometer).

An example of an anemometer may have some combination of the following characteristics: capable of measuring air velocity, being capable of measuring air temperature, being capable of calculating airflow in unit volume per time, having a probe that extends from the inspection apparatus no more than 10 cm (more preferably no more than 8 cm, more preferably no more than 6 cm, or even more preferably no more than 4 cm).

The anemometer may be particularly advantageous for asset inspections involving fluid leak detection. In this regard, the concentration of a fugitive fluid in the atmosphere and/or a leak rate may be determined. The concentration may be determined by the chemical sensor described above.

The anemometer may be employed for estimating a leak rate (i.e., volume per unit time). An algorithm and/or model may be used to determine leak rate from concentration (as determined from an open air optical path gas sensor) and wind speed correlated to the concentration measurements.

The plurality of sensors may include one or more thermographic cameras. The thermographic camera may function to convey electromagnetic radiation in the infrared spectrum (e.g., about 700 nm to 1 mm) into an image. Thermal measurements may be visually conveyed (e.g., on a graphical user interface) as a heat map. The image may be displayed in pseudo-color.

The plurality of sensors may include one or more acoustic sensors. The acoustic sensor may include a microphone. The microphone may function to convey mechanical wave properties into an analog signal (e.g., by the interaction of mechanical waves with a diaphragm). The inspection apparatus may comprise an analog-to-digital converter for converting the analog signal into a digital format. The microphone may include a directional microphone (e.g., parabolic microphones, shotgun microphones, boundary microphones, phased array microphones, or any combination thereof), although the present teachings contemplate that the microphone may include any other types of microphones, such as omnidirectional microphones (e.g., paired with post-processing, such as phased array processing, for determining the directionality of signals).

The inspection apparatus may comprise one or more real time clocks (“RTC”). The RTC may function to measure passage of time (e.g., in terms of world time or as a timer initiated during an inspection event). The RTC may cooperate with the plurality of sensors for time-stamping output signals (e.g., images, location coordinates, measurements of physical phenomena, etc.) from the plurality of sensors. The output signals may be synchronized based on their time-stamps.

In one example, the inspection apparatus may comprise a visual sensor (preferably a stereo camera), an optical gas imager (preferably a tunable diode laser), an anemometer (preferably a hot wire anemometer), a location module (preferably a GPS module), and a real time clock.

In one example, the inspection apparatus may comprise a visual sensor (preferably a stereo camera), an optical gas imager (preferably a tunable diode laser), a thermographic camera, an anemometer (preferably a hot wire anemometer), a location module (preferably a GPS module), and a real time clock.

In one example, the inspection apparatus may comprise a visual sensor (preferably a stereo camera), a thermographic camera, a location module (preferably a GPS module), and a real time clock.

In one example, the inspection apparatus may comprise a visual sensor (preferably a stereo camera), a microphone, a location module (preferably a GPS module), and a real time clock.

### Method

The present disclosure provides for a method of determining a position and an orientation (“pose”) of one or more sensors within an environment having one or more objects arranged therein. The sensor may include a visual sensor (e.g., a camera) and optionally one or more other types of sensors discussed herein. Typically, a pose of at least a visual sensor may be determined and a pose of one or more other sensors may be determined based on the pose of the visual sensor, understanding that visual data may provide comparatively greater detail that aids in the accuracy of the outputs of the neural networks discussed herein.

The method may comprise acquiring a training set of data of the environment and the one or more objects arranged therein. The training set of data may include visual data and optionally one or more other types of data. The one or more other types of data may include electromagnetic data, acoustic data, chemical data, or any combination thereof. The data may be transformed into 2D images. That is, the data may include, for each pixel, RGB data (although other color models may be contemplated by the present teachings), depth data, single-spectral electromagnetic data, multi-spectral electromagnetic data, thermal data, chemical data, acoustic data, or any combination thereof.

The training set of visual data may be acquired by two visual sensors in the form of a stereo camera. The stereo camera may provide depth data for each pixel. The depth data may be provided in the form of a depth map, which may be employed by the present method as discussed herein.

The training set of data may include sensor poses. That is, each image in the training set of data may have a sensor pose attributed thereto, referred to herein as an image and pose pair. The known sensor poses may provide for the training of a NeRF neural network, discussed below.

The training set of data may contain a finite quantity of image and pose pairs. This quantity may be limited as memory (e.g., non-transient storage media), bandwidth, and inspection time are typically limited. The training data set may be extended with synthetic image and pose pairs generated by an interpolation neural network as discussed herein.

The method may comprise training an interpolation neural network. The interpolation neural network may be trained so that it can predict a synthetic image from a pose provided to the interpolation neural network as an input. An exemplary interpolation neural network may include NeRF. The NeRF neural network is a fully connected, multi-layer, perceptron. The interpolation neural network may be trained with the training set of visual data and optionally the training set of one or more other types of data discussed herein. Known poses from image and pose pairs may be input into the interpolation neural network and the interpolation neural network may output a synthetic image and pose pair.

The interpolation neural network may be differentiable, the interpolation neural network may be backpropagated to correct the weights applied in each layer. This may result in greater accuracy in the output of the neural network (i.e., a synthetic image prediction that is accurate to a corresponding genuine image).

The interpolation neural network may employ an interpolation algorithm. The interpolation algorithm may be employed three ways in the present method. The interpolation algorithm may be employed to generate synthetic visual images, to refine poses, and to generate synthetic image and pose pairs from types of data other than visual (e.g., thermal), as discussed below.

The interpolation neural network may be depth-supervised (e.g., DS-NeRF). Depth-supervised neural networks may be trained with visual images including depth data. Depth supervision may contribute to the photorealism of synthetic images.

The method may comprise training a first convolutional neural network (CNN). The CNN may be trained so that it can semantically segment a 2D input image.

Typically, the training set of visual data may be semantically segmented by the CNN understanding that visual images provide comparatively more detail than thermal images since not all edges and features of an object may be conveyed in thermal images.

As discussed herein, images of one or more other types of data may be aligned with visual images. A semantically segmented 2D input image may be provided as a mask that may be overlaid onto the aligned images of other types of data to identify measurable quantities (e.g., temperature) of segmented features within the image.

The method may comprise training a second convolutional neural network (CNN). The second neural network may be trained so that it can estimate a pose of the 2D input image.

The 2D input image may be comprised by the training set of data, synthetic images, or both. The synthetic images may be predicted by an interpolation neural network. The synthetic images may be obtained from the training of the interpolation neural network.

As a result of training, ground truths may be established for individual features in a 2D image. The CNN may be differentiable; thus, the CNN may be backpropagated to correct the weights applied in each convolution. This may result in greater accuracy in the output of the CNN (i.e., identification of features accurate to the ground truths).

The interpolation neural network may be trained prior to the CNN. In this regard, genuine image and pose pairs and synthetic image and pose pairs obtained from training the interpolation neural network may be employed to train the CNN. The CNN may be trained prior to the interpolation neural network. In this regard, genuine image and pose pairs may be employed to train the CNN.

The CNN may employ a Differentiable Sample Consensus (DSAC) algorithm. The DSAC algorithm may be modified for the present teachings. In this regard, a parametric rectified linear unit (“PRELU”) activation function, additional residual neural network blocks, or both may be employed. PReLU may be employed in lieu of a rectified linear unit (“ReLU”) activation function, which is conventionally used. Three residual neural network blocks are conventionally used. However, the neural network of the present teachings may employ four or more residual neural network blocks. PReLU may reduce the time for training the neural network relative to ReLU. The use of PReLU and four or more residual neural network blocks provide for the accuracy of the present method.

The training set of data may comprise genuine 2D images. The genuine 2D images may be obtained from a visual sensor and optionally one or more other types of sensors discussed herein; a 3D model constructed from 2D images obtained from a visual sensor and optionally one or more other types of sensors discussed herein; or both. In other words, genuine 2D images refer to 2D images that are ultimately derived from a sensor observing an object. Obtaining the genuine 2D images from a 3D model may involve manipulating the 3D model in digital space and capturing still frames of the same.

The genuine 2D images may be semantically segmented by a human. The 2D images may be processed using feature extraction software. Classes may be applied to extracted features by a human.

The genuine 2D images may be semantically segmented by a neural network. The neural network may be trained beforehand. The neural network may be trained with 25 or more, 50 or more, 75 or more, or even 100 or more 2D images. The neural network may be trained with 200 or less, 175 or less, 150 or less, or even 125 or less 2D images. The 2D images provided to train the neural network may be acquired by a visual sensor, one or more other types of sensors discussed herein, from a computer-assisted design 3D model, or any combination thereof. The trained neural network may apply classes to features that are identified by the neural network.

The training set of visual data and/or the training set of thermal data may comprise 2D images obtained from a synthetic 3D model. The synthetic 3D model may be constructed by a human via CAD software, photogrammetry software, point cloud software, or any combination thereof. Obtaining the synthetic 2D images from a synthetic 3D model may involve manipulating the synthetic 3D model in digital space and capturing still frames of the same. The synthetic 3D model may be obtained from a catalogue. In some circumstances, manufacturers of objects that may be observed in the present method may provide the catalogue.

The 2D images obtained from a synthetic 3D model may be semantically segmented by a human. The 2D images may be processed using feature extraction software. Classes may be applied to extracted features by a human.

In some cases, the synthetic 3D model may be constructed for different sub-components of an object, in the form of different files, and possibly the sub-components can be arranged together to form the object, in a single file. In this regard, feature extraction may not be necessary. Moreover, the synthetic 3D model may comprise classes applied to sub-components and/or the object and thus a separate step of semantic segmentation may not be necessary.

The present teachings contemplate that one or any combination of sources of training sets discussed above may be employed. That is, genuine 2D images obtained from a sensor and semantically segmented by a human, genuine 2D images obtained from a sensor and semantically segmented by a neural network, genuine 2D images obtained from a 3D model and semantically segmented by a human, genuine 2D images obtained from a 3D model and semantically segmented by a neural network, 2D images obtained from a synthetic 3D model and semantically segmented by a human, 2D images obtained from a synthetic 3D model and semantically segmented by a neural network, 2D images obtained from a synthetic 3D model comprising pre-designated classes, or any combination thereof.

In general, the training set of data may provide a plurality of views, from different poses, of objects and/or an environment. The views of the training set of data may be leveraged to generate synthetic views from poses that were not in the original training set of data. The training set of data and/or the synthetic views may be employed by a neural network described herein to generate synthetic views from an inspection set of data.

Preferably, the training set comprises 2D images obtained from a synthetic 3D model and semantically segmented by a human. In this regard, the accuracy of the training set source may be comparatively greater than that of the other sources that involve at least some degree of data transformation by a computer, interpolation, and/or neural network class designation.

A plurality of color textures may be applied to the synthetic 3D model. The 2D images may be obtained from different still frames with each of the plurality of color textures applied. There may be 3 or more, 5 or more, 7 or more, or even 9 or more color textures. There may be 17 or less, 15 or less, 13 or less, 11 or less color textures. In this regard, the CNN and the interpolation neural network may be trained to identify the same object with different colors applied thereto.

Applying a plurality of color textures may address the challenge that a color of an object observed by a visual sensor may be different from the color texture applied to the synthetic 3D model and resulting in comparatively less accuracy of the CNN and the interpolation neural network in correctly identifying objects by their features. By way of example, a carbon steel pipe may be provided by a manufacturer with no coating (e.g., colored powder coating) but the end-user may coat the pipe, and thus, the color texture applied to a synthetic 3D model may be different from the coating color observed by a visual sensor. While the present method may be performed only considering geometry, depth, or both, it is understood that additional object properties, such as color, may increase the accuracy of semantic segmentation and synthetic image prediction.

Weights applied by the CNN and/or the interpolation neural network may be biased in favor of geometry over color. In this regard, differences in color between a training set of data and an object observed by a visual sensor may negatively impact the accuracy of correctly identifying objects by their features comparatively less than if geometry and color were weighted equally, or color weighted greater than geometry. Adjusting the weights may be performed in lieu of applying a plurality of color textures.

It may be preferable to apply a plurality of color textures rather than adjusting the weights understanding that color can be a useful parameter to identify objects via a neural network. However, the importance of color may be case-specific. For example, color may not be as useful in distinguishing objects if all of the objects observed by a visual sensor have the same or substantially the same color.

Weights applied by the CNN and/or the interpolation neural network may consider depth data and ignore color. In this regard, the depth data may function as a substitute for color in providing for the accuracy of object identification. Depth data may be visually conveyed by a depth map, which, like 2D RGB images, may be useful in differentiating geometry within 2D images. Moreover, depth maps can define spatial relationships between different objects within 2D images.

The ability for the interpolation neural network to accurately predict depth increases relative to the size of the training set of data. An insufficient training set may result in depth predictions with obscured geometry (e.g., obscured edges of an object). The training set of data may comprise 10 or more, 20 or more, 30 or more, or even 50 or more 2D images with depth data. The training set of data may comprise 100 or less, 90 or less, 80 or less, or even 70 or less 2D images with depth data.

The method may comprise acquiring an inspection set of data of the environment and the one or more objects arranged therein. The inspection set of data may include visual data and optionally one or more other types of data discussed herein. That is, 2D images captured and/or inferred by the visual sensor and one or more other types of sensors, whereby the data may include, for each pixel, RGB data (although other color models may be contemplated by the present teachings), depth data, single-spectral electromagnetic data, multi-spectral electromagnetic data, thermal data, acoustic data, chemical data, or any combination thereof.

The electromagnetic data may include radiation, reflection, absorption, or any combination thereof. The acoustic data may include amplitude. The chemical data may include concentration.

The inspection set of data may be acquired by one or more visual sensors and optionally one or more other types of sensors discussed herein. The sensors may be the same as or different from the sensors that acquired the training set of data. The inspection set of visual data may be acquired by two visual sensors in the form of a stereo camera and/or a multi-lens camera. The stereo camera and/or multi-lens camera may provide depth data for each pixel.

At least visual data acquired by visual sensors may be employed to generate one or more images and/or one or more point clouds for 3D models. In this regard, any other types of data (e.g., thermal data, single-spectral electromagnetic data, multi-spectral electromagnetic data, chemical data, acoustic data, or any combination thereof) may be mapped onto an image or a point cloud. In other words, any type of data discussed herein may be associated with coordinates in Euclidean space. By such coordination, users may visualize different types of data on 2D images and/or 3D models. Moreover, as will be discussed herein, the present method seeks to provide textures of data acquired from different types of sensors (e.g., thermal sensors) that cooperate on a pixel-by-pixel basis with visual data.

The method may comprise estimating one or more poses of corresponding one or more input images from the inspection set of visual data and optionally the inspection set of thermal data. The poses may be estimated by the CNN. The CNN may include one or more layers that function to estimate the poses of semantically segmented images. The output of the CNN (the estimated pose) may be referred to herein as a coarse pose. A coarse pose is so-termed relative to a fine pose, which is discussed hereunder.

Regarding thermal data, or other types of data discussed herein, semantic segmentation may assist in organizing inspection data. In one aspect, a human operator may view a thermal image mapped onto a visual image to determine the temperature of an object and/or subcomponents thereof. In another aspect, all temperature measurements of a single object can be averaged (e.g., mean, median, mode) or otherwise analyzed (e.g., maximum, minimum, etc.) and such quantity can be attributed to the object and/or sub-component, as the object and/or sub-component is identified by the features thereof.

The method may comprise generating one or more synthetic images for corresponding one or more coarse poses. The synthetic images may be generated by an interpolation neural network. The interpolation neural network may receive a coarse pose from the CNN and output a synthetic image corresponding to the coarse pose. The synthetic image is predicted by the interpolation neural network based upon the training set of data and the coarse pose estimated by the CNN.

Where the interpolation neural network predicts synthetic images for non-visual types of data discussed herein, the coarse pose of an image is assumed to be equal to the coarse pose of the corresponding visual image. This assumption may be based on a sensor being located on-board the same robot as the visual sensor. In this regard, the sensors may be located close to each other (e.g., distanced by about 60 cm or less, 50 cm or less, 40 cm or less, 30 cm or less, 20 cm or less, or even 10 cm or less). This assumption may be adjusted in the refining step discussed below.

The coarse pose estimated by the CNN may ease processing operations in the refining step. That is, since the refining step seeks to adjust the coarse pose such that the synthetic image cooperates with the input image, the more adjustment required in refining, the more processing time may be required. The present method seeks to employ a CNN that estimates a coarse pose that is close to the actual pose of the sensor. The coarse pose may deviate by 5% or less, 2% or less, 1% or less, or even 0.1% or less from the actual pose of the sensor.

The method may comprise refining the one or more coarse poses. The coarse poses may be refined to obtain a fine pose. The coarse poses may be refined by minimizing the difference between the synthetic image and the input image. This may apply to visual images and optionally images generated from any other type of sensor discussed herein (e.g., thermal, acoustic, chemical, etc.). In this regard, the synthetic image may be shifted such that individual pixels of the synthetic image correspond to individual pixels of the input image. Such shift of the synthetic image can be characterized by a corresponding shift applied to the coarse pose. By way of example, shifting the pose of a visual sensor by 10 cm in the X direction results in a corresponding shift in the pixels of an image.

Refinement of visual images and thermal images may be performed in-series or simultaneously. The visual image may be refined and then the thermal image may be refined.

A form of the interpolation neural network may be employed for refining the coarse poses. For example, iNeRF (Inverting Neural Radiance Field) may be employed. iNeRF may comprise an additional head for refining the coarse pose of non-visual images. Thus, refining the coarse poses of a visual image and a corresponding non-visual image may be performed simultaneously.

Head, as referred to herein, may mean modules of a neural network specialized for determining a desired output. Each head may receive an input from the backbone of the neural network and generate a desired output. The input from the backbone may be common to all the heads. The outputs of each head may be unique relative to the other heads. For example, a first head may be configured for predicting synthetic visual images (e.g., replicating an image including data that would otherwise be obtained from a camera) and a second head may be configured for predicting synthetic non-visual images (e.g., replicating an image including data that would otherwise be obtained from non-visual sensors described herein such as a chemical sensor, a thermal sensor, an acoustic sensor, or any combination thereof. Discrete types of non-visual data may be processed by unique heads.

The fine pose may be about 99% or more, 99.5% or more, or even 99.9% or more accurate to the actual pose of the sensor that obtained the input image. The present teachings contemplate that it is possible, in some circumstances, that the coarse pose may be as accurate to the actual pose as the intended accuracy of a fine pose. In this regard, refining may not be performed for a given image. However, typically the coarse pose may be less accurate to the actual pose relative to the fine pose.

The method of the present teachings may not require location tracking technology on-board a sensor. Inspection data may include images with no known pose. However, by the present method, pose may be determined.

The fine pose determined by the present method may be employed for downstream processes, as discussed herein.

The present method may employ the CNN utilizing DSAC and the interpolation neural network (including variations thereof discussed herein) in a unique and unconventional manner. Alone, a CNN can semantically segment images and an interpolation neural network can predict synthetic images. By the present teachings, it is proposed that the two are employed together in a process that determines the pose of a sensor that obtained an image. Thus, images can be localized with no location tracking technology.

The method may comprise removing outliers from the one or more synthetic images. Typically, the present method may be performed on an inspection data set comprising a plurality of 2D images and by the present method, a plurality of corresponding synthetic images may be predicted. It is contemplated that the CNN may not accurately estimate a pose and/or the interpolation neural network may output a synthetic image that is not accurate to the corresponding input image. That is, differences in 3D location (x, y, z), 3D viewing direction (φ, θ, Y), radiance (r, g, b), volume density (σ), or any combination thereof. Inaccurate pose estimation by the CNN may result in an error in the interpolation neural network. Inaccurate synthetic images may require additional processing time to refine the coarse poses thereof. If outliers remain in the resulting set of image and pose pairs, then follow-on 3D modelling and/or 2D image stitching may be inaccurate. Moreover, time-lapse comparison may be compromised.

The synthetic images may be compared to the corresponding input images and the differences may be quantified. If the differences exceed a threshold, the synthetic image and pose pair may be treated as an outlier. Outliers may be removed.

The threshold may be set at 5% or more, 10% or more, or even 15% or more.

The outliers may be removed to reduce the data size to be processed downstream, to reduce the data size to be communicated over a network, to avoid errors in 3D modeling, to avoid errors in 2D image stitching, to avoid errors in time-lapse comparison, to avoid errors in robotic element movement, or any combination thereof. Removal of outliers may not impact downstream processes flowing from the present method, as the downstream processes (e.g., time-lapse comparison) may employ a plurality of synthetic image and pose pairs.

The method may comprise comparing time-lapse data. The time-lapse data may comprise an inspection data set from a first inspection event and an inspection data set from a second inspection event. The first inspection event may occur prior-in-time to the second inspection event. The inspection events may be separated by 1 day or more, 3 days or more, 1 week or more, or even 2 weeks or more. The inspection events may be separated by 5 years or less, 1 year or less, 6 months or less, or even 1 month or less. Typically, inspections may occur on a regular or semi-regular schedule.

Comparison of time-lapse data may detect changes in an environment and/or objects arranged therein over time. For example, corrosion of a pipe may be detected. In this regard, 2D images and/or 3D models from a first inspection event and a second inspection event may be compared. In order to enable such comparison, sensor pose must be known such that, e.g., a 2D image from the first inspection event can be compared to a 2D image with a corresponding pose from the second inspection event. Otherwise, if the pixels in two different images are not aligned, comparison of the same may convey changes that are not actually present in the objects, or the magnitude of changes may not be accurate. As described above, the present disclosure provides a method for determining sensor pose without the need for location tracking technology.

In some circumstances, an image from a first inspection event may not correspond to an image from a second inspection event. That is, even if a sensor observes the same object from generally the same location, a frame may not be captured from the exact same pose.

The method may comprise comparing the pose of a first image from a first inspection event with the pose of a second image from a second inspection event. If the pose of the first image does not correspond to the pose of the second image, a synthetic image interpolated from the inspection set of data of the first inspection event or the inspection set of data of the second inspection event may be predicted.

The method may comprise predicting, via the interpolation neural network, a synthetic image. The pose of the first image from the first inspection event or the pose of the second image from the second inspection event may be provided as an input to the interpolation neural network. The synthetic image may be predicted from the pose.

The method may comprise comparing a genuine image with the synthetic image. The genuine image may be associated with the first inspection event and the synthetic image may be associated with the second inspection event, or vice versa. As the synthetic image is predicted from the same pose as the genuine image, time-lapse comparison may be performed.

The present disclosure contemplates that in lieu of a first inspection event, 2D images may be obtained from a synthetic 3D model. In this regard, a current state of an environment and/or an object may be compared to a like-new state of the same. For example, a synthetic 3D model may be constructed for a pipe, as it would be first sold to a customer and the current state of the pipe (e.g., 1 year after purchase and/or first use) may be compared to the like-new state of the pipe.

A first inspection set of data and/or a second inspection set of data may be supplemented with synthetic images from missing poses. Any given inspection set of data may comprise a finite quantity of images from a finite quantity of poses. It may not be practical to obtain an inspection set of data for all possible poses of a sensor along an inspection path due to inspection time constraints, storage medium (e.g., non-transient storage medium) size, bandwidth limitations, processing time, and the like. It also may not be practical or even possible to predict all possible poses of a sensor due to various factors such as mechanical failures in a locomotive system, ground conditions, weather conditions, path blockages, tolerances inherent in locomotive systems, asynchronous frame rates, the like, or any combination thereof.

In this regard, synthetic images may be generated from poses not present in the inspection set of data. As described hereinbefore, synthetic images may be generated for poses that correspond to poses of genuine and/or synthetic images from an inspection data set acquired prior-in-time. In this regard, NeRF may be employed.

The method may comprise rendering one or more synthetic 3D models. The synthetic 3D model may be rendered based on genuine images of an inspection set of data and their fine poses determined as discussed herein. Synthetic image and pose pairs may also be used to render the synthetic 3D models.

The method may comprise retexturing the synthetic 3D model. The synthetic 3D model may be retextured with synthetic images predicted from synthetic poses. The synthetic poses may be chosen to correspond with poses that are present in a prior-in-time inspection event but missing in the current inspection event.

The method may comprise comparing the original and/or retextured synthetic 3D model with a pre-existing synthetic 3D model. The pre-existing synthetic 3D model may be a CAD 3D model, rendered from 2D images obtained from a previous inspection event, rendered from LIDAR point cloud data acquired from a previous inspection event, or any combination thereof. The comparison may determine the presence of any changes and/or anomalies associated with the environment and/or one or more objects situated in the environment.

The pre-existing synthetic 3D model may comprise a meshed point cloud. The meshed point cloud may or may not include color data. The color data may or may not be light compensated.

The method may comprise localizing one or more robotic elements and/or human-held elements. The fine pose determined as discussed herein may be employed for the interaction of one or more robotic elements and/or human-held elements with the environment and/or the 3D object. The human-held element may lead a human operator within the environment and/or 3D object.

The robotic elements may be affixed to a robot (e.g., a ground-mobile and/or air-mobile robot) discussed hereinbefore. The robot to which the robotic elements are affixed may be the same as the robot to which one or more sensors employed in the pose determination method discussed herein are affixed. The one or more robotic elements may include one or more robotic arms. The robotic arms may include one or more gripping devices, tools, sensors, or any combination thereof.

The human-held element may comprise one or more sensors. The one or more sensors may be the same as the one or more sensors employed in the pose determination method discussed herein.

The robotic elements and/or human-held elements may be employed for maintenance and/or further inspection operations. By way of example, a robotic arm with a tool attached thereto may perform maintenance on an object with which a change and/or anomaly was detected by time-lapse comparison. By way of another example, a robotic arm with a sensor affixed thereto may perform a secondary inspection. By way of another example, a human operator may be dispatched to a point and/or region of interest to perform maintenance and/or further inspection operations.

The secondary inspection may be more detailed than a primary inspection performed by one or more visual sensors as discussed hereinbefore. The secondary inspection may employ the same and/or one or more different types of sensors than the sensors employed for acquiring the inspection set of data.

Locomotion of a robot to an object of interest or the general area thereof may involve a human operator piloting the robot thereto.

Locomotion of a robot and/or human operator to an object of interest or the general area thereof may involve re-tracing the path traversed during an inspection event and stopping at a location corresponding to a timestamp of an image acquired during the inspection event.

Locomotion of a robot and/or human operator to an object of interest or the general area thereof may involve reference to a 3D model of an environment. By the image localization techniques described herein, an object of interest may be identified by the pose of an image acquired thereof and a path may be traced from an origin of the robot to the location conveyed by the pose.

Sensors on-board the robot and/or the human-held element may traverse the path and observe the objects along the path. The robot and/or human operator may stop when sensors observe the object of interest.

Locomotion of a robot and/or human operator to an object of interest or the general area thereof may involve location tracking technology. By the image localization techniques described herein, an object of interest may be identified by the pose of an image acquired thereof and coordinates may be provided to the robot and/or the human-held element so a path may be traced from an origin of the robot to the coordinates, which correspond to the pose.

Once at the object of interest or the general area thereof, the robot and/or human operator may approach a point of interest and/or a region of interest on the object. One or more sensors (e.g., visual sensors) may observe the object. Thus, by the method described herein of obtaining a pose from an image acquired by a sensor, the robot may adjust its pose by comparing the determined pose of currently observed images to the pose of images acquired during a previous inspection event and moving toward said pose. The human-held element may compare the determined pose of currently observed images to the pose of images acquired during a previous inspection event, and direct the human operator to move toward said pose.

The human-held element may comprise a digital display. The digital display may guide the human operator relative to the object of interest, point of interest, region of interest, or any combination thereof. In this regard, one or more sensors on-board the human-held element may obtain data that is transformed, by the method described herein, into a picture on the digital display that guides the human operator.

Once at the point of interest and/or region of interest on the object, the robotic element may move to interact with the same. Such interaction may be a direct, physical interaction (e.g., with a tool) or an indirect, observational interaction (e.g., close-up inspection by a sensor). In this regard, one or more sensors may guide the movement of the robotic element and/or a human operator may guide the movement of the robotic element.

The robotic element may comprise one or more position sensors. The position sensors may include linear position sensors, angular position sensors, rotary position sensors, or any combination thereof. The position of the robotic element, detected by position sensors, may be related to the pose of a sensor (e.g., visual sensor) on-board the same robot.

By the method discussed herein a sensor (e.g., visual sensor) may acquire an image of an object and determine the pose from which the image was acquired. The sensor pose may be related to the pose of the robotic element by feedback from one or more position sensors of the robotic element.

The method may comprise determining the position and/or orientation of other sensors. Typically, a visual sensor may provide data from which other sensors can be localized, given that visual sensors provide comparatively more detail. The other sensors may include one or any combination of those discussed herein. The other sensors may be affixed to the same robot as the visual sensor.

The other sensors may be in a fixed relationship and/or a dynamic relationship relative to the visual sensor and/or each other. In a fixed relationship, differences in pose can be measured and calibration of the other sensors to the visual sensor can proceed by accounting for those differences. For example, an image acquired from a thermal sensor statically located 10 cm below a visual sensor can be adjusted proportionally to the distance between the sensors. Moreover, in a fixed relationship, calibration may occur only once. In a dynamic relationship, differences in pose can be measured dynamically by one or more position sensors. The position sensors may include linear position sensors, angular position sensors, rotary position sensors, or any combination thereof.

Sensors in a dynamic relationship to each other may be calibrated by the pose determination method described herein. That is, images from different sensors may have their coarse pose estimated by a CNN, synthetic images predicted by an interpolation neural network, and coarse poses adjusted to determine fine poses. Such adjustment of other sensors to cooperate with input visual images may relate back to the pose of the other sensors relative to the visual sensor.

Synthetic images may be generated for other sensors described herein (e.g., thermal, acoustic, chemical, etc.) by employing the same CNN and interpolation neural network developed for the visual sensors discussed above. Localization of the other sensors may aid in generating the synthetic images.

The method may comprise identifying one or more objects. Object identification may bolster the pose determination and follow-on processes (e.g., time-lapse comparison and robotic element articulation). Object identification may include the location of objects within the environment. One example of the benefit of identification by location may be realized in environments having multiple of the same objects or even similar objects.

Objects may be identified by a convolutional neural network. The CNN may be trained to establish ground truths. Images acquired during an inspection event may be provided as an input into the CNN and objects in the images may thereby be identified.

Objects may be identified by sensor pose. Poses may be determined for images acquired during an inspection event. The poses may be cross-referenced to a prefabricated map and/or 3D model of the environment. The identity, including location, of objects may be set forth in the prefabricated map and/or 3D model. The prefabricated map may be in a digital format.

Objects may be identified by time-stamping images. During an inspection event, each frame acquired by a sensor may be time stamped and the robot may traverse a pre-determined path. Thus, given a known rate of travel along the path, the time stamp may indicate the location from which an image is acquired. Given a pose determined for the image, the timestamp and pose can be cross-referenced to a prefabricated map and/or synthetic 3D model of the environment. The identity, including location, of objects may be set forth in the prefabricated map and/or synthetic 3D model.

In some aspects, location tracking technologies may be employed in the pose determination. The location tracking technologies may include GPS, IMU, or the like. Images from inspection events may be tagged with the location the image was obtained from. Location tracking may be particularly useful in environments having a plurality of objects that have the same or similar appearance (e.g., a field of solar panels). In this regard, object identification performed solely on the basis of visual data input into a neural network may not distinguish between different objects having the same or similar appearance.

A combination of GPS and IMU may be employed. GPS may provide the position of a sensor. IMU may provide the position and/or orientation of a sensor. Location data may be employed to constrain the pose estimation. That is, constrain the coarse pose to the general position and orientation provided by the location data. Understanding that tolerances are inherent in GPS and IMU technologies, the tolerances may be accounted for in the location data attributed to each image and/or the constraints imposed on the pose estimation. That is, a measured position and/or orientation via GPS and/or IMU may not be treated as an absolute pose. The constraints may function to filter outliers. One example of outliers that may be encountered in this field is images obscured by lighting glare (e.g., from the sun) obfuscating the image.

The method may comprise stitching together genuine 2D images and/or synthetic 2D images. The stitched 2D images may be coordinated according to the pose of each 2D image. The 2D images may be stitched as a panorama. The 2D images may be projected onto a cylindrical medium. In this regard, an explorable digital environment may be constructed from 2D images. The stitched 2D images may be distinct from 3D modelling, while providing a similar exploration experience. Like exploring a 3D model, human operators can explore a digital space recreated from stitched 2D images.

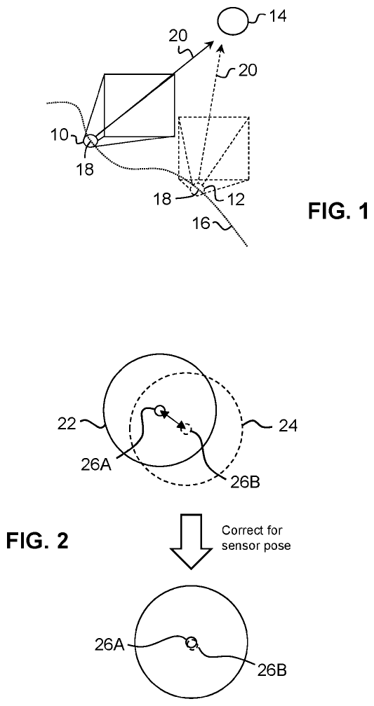

FIG. 1 illustrates a diagram of a genuine sensor 10 and a synthetic sensor 12 relative to a 3D object 14. The genuine sensor 10 traverses a path 16 and acquires data associated with the 3D object 14 from one or more different poses. One or more synthetic sensors 12 may be placed in the environment. The synthetic sensors can be thought of as imaginary sensors from which predicted synthetic images are acquired. The location of the sensors 10, 12 on the path 16 is referred to herein as the position 18 (i.e., one component of the pose). The pose is also defined by the orientation 20 of the sensors 10, 12.

FIG. 2 illustrates a diagram of time-lapse data comparison. From a first set of visual data collected at a first point in time, a first image 22 can be generated. From a second set of visual data collected at a second point in time, a second image 24 can be generated. Due to a variance in the pose of the sensor between the first point in time and the second point in time, even though the sensor acquires data from roughly the same pose, a positional difference in corresponding points 26A, 26B is realized. In absence of correcting for pose (i.e., predicting a synthetic image with a pose corresponding to the pose of the first image 22), the magnitude in positional difference appears larger than it actually is. However, by correcting for pose, the actual magnitude of the positional difference, if any is present, can be accurately identified.

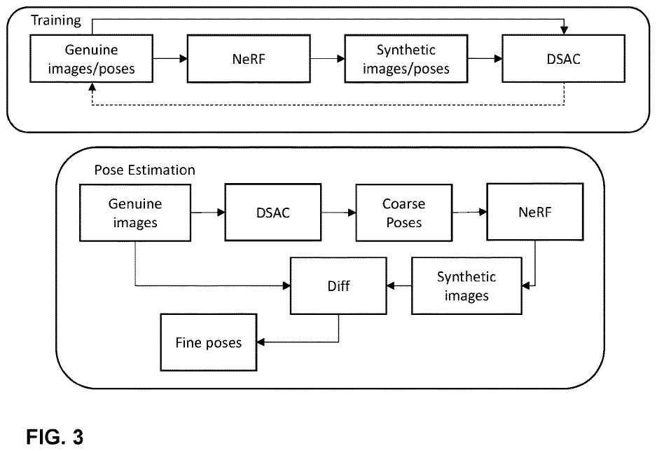

FIG. 3 illustrates a flowchart of the present method. The flowchart depicts the training the interpolation algorithm and the predicting by the interpolation algorithm.

For training, a training set of visual data and optionally thermal data comprising genuine image and pose pairs is input into a NeRF neural network and synthetic image and pose pairs are output from the same. The present disclosure contemplates that any suitable interpolation neural network may be employed. The genuine image and pose pairs and synthetic image and pose pairs may be input into a CNN employing DSAC for training the CNN, which then refines the synthetic pose estimation.

The refined synthetic poses may be employed to optimize the original poses.

The present disclosure contemplates that the NeRF neural network and the CNN can be trained in parallel. That is, the genuine image and pose pairs can be provided to both the NeRF neural network and the CNN. The present disclosure contemplates that the genuine image and pose pairs may be input into the CNN as well as the synthetic image and pose pairs. In this regard, the synthetic image and pose pairs may provide additional data for training the CNN. The present disclosure contemplates that the CNN may be trained before training the NeRF neural network.

For predicting, an inspection set of visual data and optionally thermal data is input into the trained CNN employing DSAC, which estimates coarse poses of the images. The coarse poses are input into the trained NeRF neural network, which predicts synthetic images associated with the coarse poses. The coarse pose is refined such that differences (Diff) between genuine images and corresponding synthetic images are minimized to produce fine poses.

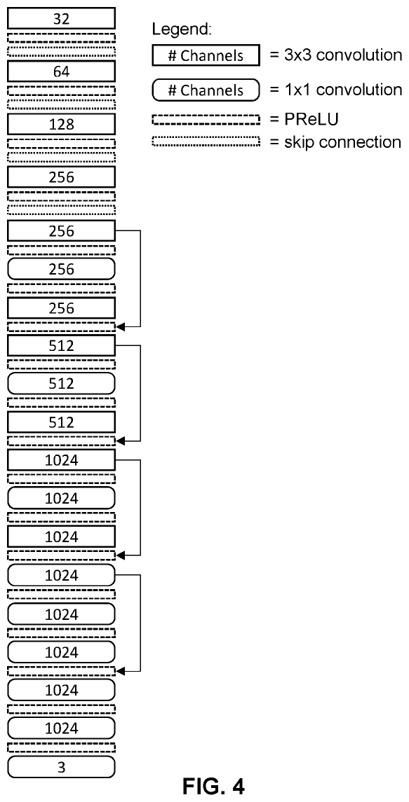

FIG. 4 illustrates the architecture of the convolutional neural network (CNN) employed by the present teachings. The convolutional neural network may function to estimate the coarse pose of an input image. The CNN architecture comprises 3×3 convolutions and 1×1 convolutions. Each convolution is characterized by a number of channels, indicated in FIG. 4. Between each convolution, a PReLU activation function is applied and/or a skip connection is present. The CNN comprises four residual neural network blocks indicated by arrows from a convolutional layer to a later activation function.

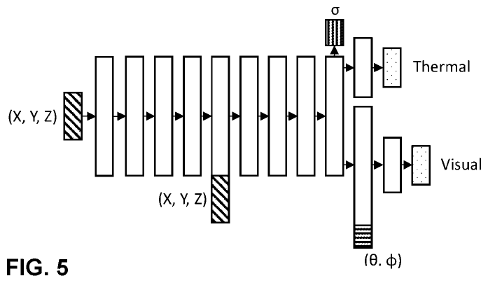

FIG. 5 illustrates the architecture of the interpolation neural network employed by the present teachings. The neural network has been trained with images including depth data, thus, the neural network is depth supervised. As an input, an encoded position component (X, Y, Z) of pose is input into the neural network at the outset and an encoded orientation component (θ, φ) of the pose is input in the visual image head of the neural network.

Multiresolution hash encoding described in Müller et al, Instant Neural Graphics Primitives with a Multiresolution Hash Encoding, ACM Trans. Graph., Vol. 41, No. 4, Article 102 (July 2022), may be used as an encoder for the position component. Spherical harmonics can be used as an encoder for the orientation component.

In each layer, a weight is applied until ultimately a thermal image and a visual image (RGB) is predicted. In the fifth layer, the position component (X, Y, Z) is input into the neural network. As the neural network is depth supervised, volume density (σ) can be interpolated from the pose and used to predict depth. Moreover, depth may be refined by correcting for the difference between the interpolated depth and a ground truth depth.

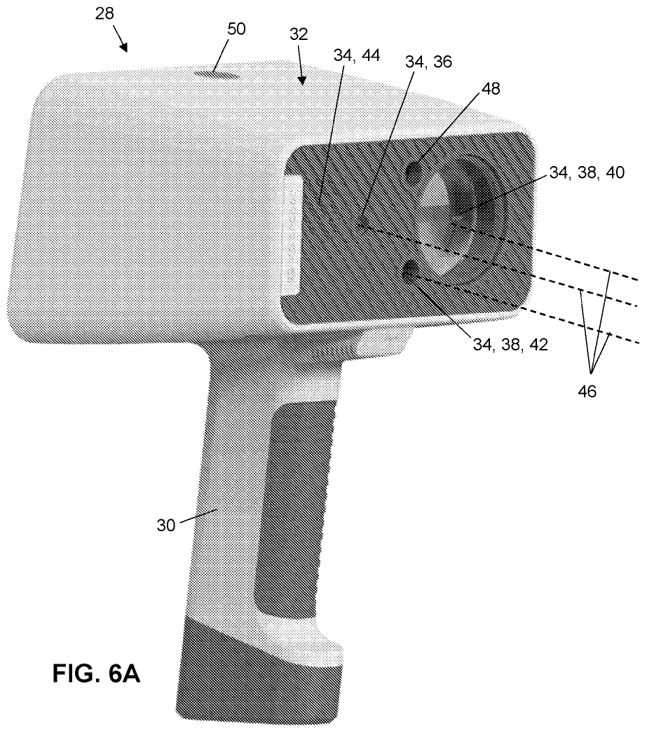

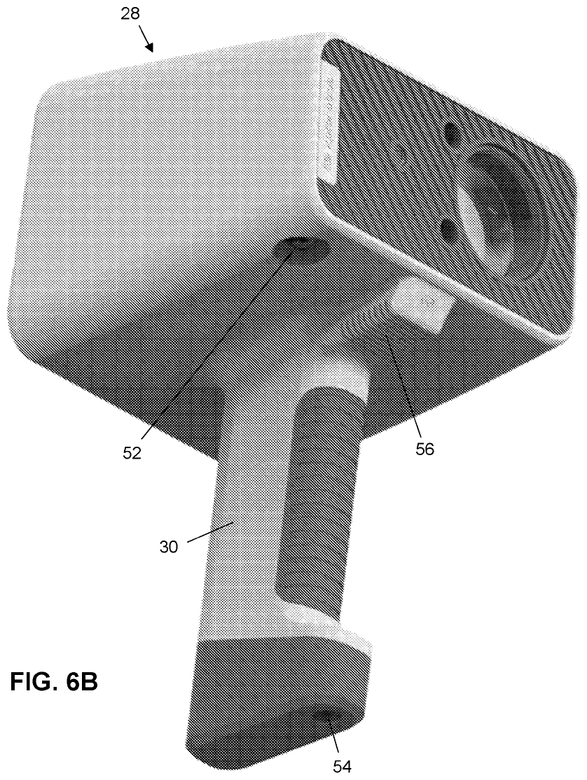

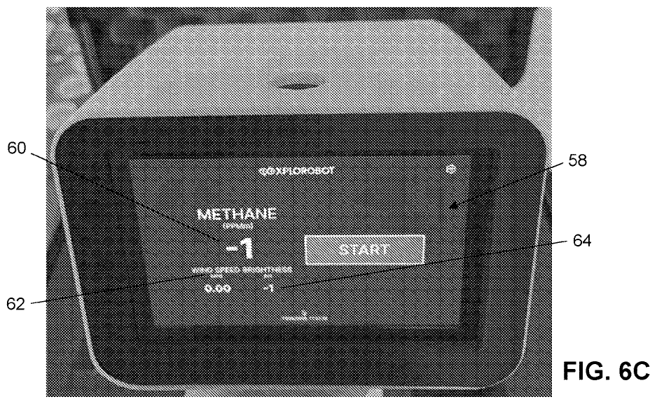

FIG. 6A and FIG. 6B show an inspection apparatus 28 according to the present teachings. The inspection apparatus 28 is a handheld device having a handle 30 and a sensor unit 32 mounted to the handle 30. The sensor unit 32 includes a plurality of sensors 34 including a visual sensor 36, an open air optical path gas sensor 38 that comprises an emitter 40 and a receiver 42 (although the present teachings contemplate sensing technologies that integrate the separate emitter and receiver), and a microphone 44. The plurality of sensors 34 have observation axes 28 that are generally parallel to one another and that are directed toward an object and/or region of interest for data collection.

The sensor unit 32 also includes a visible light laser 48 for aiding users in aiming the inspection apparatus 28. In this regard, the user can visualize where the plurality of sensors 34 are directed upon. The path of the visible light laser 48 is preferably generally parallel to the observation axes 46 of the plurality of sensors 34. A power button 50 is located on the top of the sensor unit 32, although the present teachings contemplate the power button 50 can be located anywhere on the sensor unit 32 and/or handle 30 that is practicable.

As shown in FIG. 6B, the sensor unit 32 also includes a data transmission port 52 (as shown, an ethernet port) and a power connection 54 for recharging an on-board battery (for powering the sensors, processors, graphical user interface, and the like). Underneath the sensor unit 28 and proximate to the handle 30 is located a modular access point 56 to which other sensors can be installed on the inspection apparatus 28 and through which wiring of the other sensors can pass and connect the other sensors to data transmission means and power sources. An anemometer can be installed on the modular access point 56, although the present teachings that any other sensors may be installed on the modular access point 56 (including redundant sensors such as a second visual sensor). It may be appreciated that the location of the anemometer need not necessarily be accounted for with respect to the observation axes 46 of the plurality of sensors 34 as wind speed and direction in the general area is agnostic to the direction of the sensors 34. Although, it is generally recommended that the inspection apparatus 28 be held no more than 50 meters, more preferably no more than 40 meters, more preferably no more than 30 meters, more preferably no more than 20 meters, or even more preferably no more than 10 meters from the object(s) being observed.

FIG. 6C shows a graphical user interface 58 on a side of the inspection apparatus 28 opposing the side on which the plurality of sensors 34 are located. The graphical user interface 58 displays the methane concentration 60 measured by the open air optical path gas sensor, wind speed 62 measured by an anemometer, and brightness 64 as measured by the visual sensor (brightness being relevant to the accuracy of sensor measurements relying on reflection of electromagnetic radiation).

The present teachings contemplate that the graphical user interface 58 can display any of the measurements discussed herein as well as optionally a live-feed from the visual sensor (optionally with a visualization of quantitative and/or qualitative gas measurements, thermal measurements, acoustic measurements, or any combination thereof juxtaposed on the live-feed from the visual sensor). The graphical user interface 58 is touch-screen enabled and thus users can interact with the graphical user interface 58, such as pressing the “start” button to initiate data collection and an associated “stop” button to cease data collection. The present teachings contemplate that while data may not be collected/recorded (i.e., stored on a non-transient storage medium), the inspection apparatus 28 may operate in an observation-only mode in which instantaneous measurements are displayed for the user.

Instantaneous wind speed and/or direction, brightness, or any combination thereof may be advantageous to the user in order to properly orient the inspection apparatus 28. In some aspects, an indicated wind speed and direction can prompt the user to orient the device upstream of the wind in the event the point of origin of a leak is located upstream. In some aspects, an indicated brightness can prompt the user to perform subsequent passes of the inspection apparatus 28 or wait for ambient light conditions to change in order to obtain optimal measurements. In this regard, an excess of reflected light (e.g., from the sun) can interfere with the gas measurements discussed herein. It is also contemplated by the present teachings that various visual and/or audio indicators may be expressed to the user via the graphical user interface.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. Other combinations are also possible as will be gleaned from the following claims, which are also hereby incorporated by reference into this written description. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

The terms “generally” or “substantially” to describe angular measurements may mean about +/−10° or less, about +/−5°or less, or even about +/−1° or less. The terms “generally” or “substantially” to describe angular measurements may mean about +/−0.01°or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that an amount is, for example, from 1 to 90, from 20 to 80, or from 30 to 70, it is intended that intermediate range values such as 15 to 85, 22 to 68, 43 to 51, 30 to 32, etc. are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner.

The term “consisting essentially of” to describe a combination shall include the elements, components, or steps identified, and such other elements, components, or steps that do not materially affect the basic and novel characteristics of the combination. The use of the terms “comprising” or “including” to describe combinations of elements, components, or steps herein also contemplates embodiments that consist essentially of the elements, components, or steps.

The disclosures of all articles and references, including patent applications and publications, are incorporated by reference for all purposes.

1. A method for determining a position and an orientation of at least one visual sensor within an environment having an object arranged therein, the method comprising:
acquiring a training set of visual data of the environment and/or the object;
training at least one neural network, with the training set of visual data;
acquiring, by the at least one visual sensor, an inspection set of visual data of the environment and/or the object by moving the at least one visual sensor within the environment;
estimating, via the at least one neural network, a coarse pose of an input image from the inspection set of visual data;
generating from the coarse pose, via the at least one neural network, a synthetic image associated with the coarse pose; and
refining the coarse pose, by minimizing differences between the synthetic image and the input image, to obtain a fine pose of the input image.

2. The method according to claim 1, wherein the training set of visual data comprises:
2D images derived from the at least one visual sensor; 2D images obtained from a Computer-Assisted Design 3D model; a photogrammetry-derived 3D model; a LIDAR-point-cloud-derived 3D model; a 3D model derived from any combination of Computer-Assisted Design, photogrammetry, and a LIDAR point cloud; or any combination thereof.

3. The method according to claim 1, wherein the training set of visual data is semantically segmented prior to training the at least one neural network, in order to establish ground truths that are compared to an output of the the at least one neural network to permit adjustment of weights applied by the at least one neural network.

4. The method according to claim 3, wherein the weights applied by the at least one neural network are biased in favor of geometry over color, consider depth data, ignore the color, or any combination thereof.

5. The method according claim 1, wherein the at least one neural network employs a Differentiable Sample Consensus (DSAC) algorithm.

6. The method according to claim 1, wherein the at least one neural network comprises an interpolation neural network that performs the generating of the synthetic image, wherein the interpolation neural network comprises a neural radiance field, a predictive linear optimization algorithm, or a predictive non-linear optimization algorithm; and wherein the interpolation neural network is depth-supervised.

7. The method according to claim 1, wherein the at least one visual sensor comprises two or more visual sensors, and the training set of visual data and the inspection set of visual data are acquired by the two or more visual sensors in the form of a stereo camera or a multi-lens camera.

8. The method according to claim 1, wherein an inverted neural radiance field is employed for refining the coarse poses.

9. The method according to claim 1, wherein the method further comprises removing, as an outlier, the synthetic image if the synthetic image differs from the input image by a threshold.

10. The method according to claim 1, wherein the method further comprises performing a time-lapse comparison by comparing the input image from the inspection set of visual data with a second input image from a second inspection set of visual data that was acquired prior-in-time to the inspection set of visual data; and if the fine pose of the input image does not correspond to a fine pose of the second input image, the method further comprises:
obtaining the fine pose of the input image or the fine pose of the second input image;
generating, via the at least one neural network from the fine pose of the input image or the fine pose of the second input image, a second synthetic image; and
comparing the second synthetic image to the input image or the second input image, whichever is not associated with the fine pose with which the second synthetic image was generated.

11. The method according to claim 1, wherein the method further comprises localizing a robotic element, including the following steps:
moving a robot comprising the at least one visual sensor and the robotic element within the environment to the object or a general area of the object;
moving the robot toward a point of interest and/or a region of interest on the object;
acquiring, by the at least one visual sensor, an image of the point of interest and/or the region of interest;
estimating, via the at least one neural network, the coarse pose of the image of the point of interest and/or the region of interest;
generating, via the at least one neural network, from the coarse pose, a synthetic image associated with the coarse pose;
refining the coarse pose, by minimizing the difference between the synthetic image and the image of the point of interest and/or the region of interest, to obtain a fine pose of the image;
determining the pose of the robotic element by feedback from one or more position sensors;
relating the fine pose of the image to the determined pose of the robotic element; and
repositioning the pose of the robotic element until it cooperates with the fine pose of the image.

12. The method according to claim 1, wherein the method further comprises localizing a human-held element comprising the at least one visual sensor, including:
acquiring, by the at least one visual sensor, an image of the environment;
estimating, via the at least one neural network, the coarse pose of the image of the environment;
generating, via the at least one neural network, from the coarse pose, a synthetic image associated with the coarse pose;
refining the coarse pose, by minimizing the difference between the synthetic image and the image of the point of interest and/or the region of interest, to obtain a fine pose of the image;
relating the fine pose of the image to a location of an object of interest; and
guiding a human operator holding the human-held element to the object of interest.

13. The method according to claim 1, wherein the method further comprises identifying the object; wherein the object is identified by one or more of: providing the input image to the trained at least one neural network, cross-referencing the fine pose to a prefabricated map and/or a 3D model of the environment, cross-referencing a time stamp of the input image to the path defined on a prefabricated map and/or a 3D model of the environment, and tracking a location of the at least one visual sensor.

14. The method according to any claim 1, wherein the method further comprises: training a convolutional neural network of the at least one neural network with the training set of visual data; and semantically segmenting the input image from the inspection set of visual data.

15. A method for determining a position and an orientation of a visual sensor and a non-visual sensor within an environment having an object arranged therein, the method comprising:
acquiring a training set of visual data and a training set of non-visual data of the environment and/or the object;
training at least one neural network with the training set of visual data and the training set of non-visual data;
acquiring, by the visual sensor and the non-visual sensor, an inspection set of visual data comprising an input visual image, and an inspection set of non-visual data comprising an input non-visual image, of the environment and the object by moving the visual sensor and the non-visual sensor within the environment;
estimating, via the at least one neural network, a coarse pose of the input visual image, wherein a coarse pose of the input non-visual image is assumed equal to the coarse pose of the input visual image;
semantically segmenting features of the visual input image and the non-visual input image;
generating, via the at least one neural network, from the coarse pose of the input visual image and the coarse pose of the input non-visual image, a synthetic visual image and a synthetic non-visual image associated with the coarse poses;
refining the coarse pose of the input visual image, by minimizing differences between the synthetic visual image and the input visual image, to obtain a fine pose of the input visual image; and
calibrating the input non-visual image to the input visual image by adjusting the coarse pose of the input non-visual image until the features thereof align.

16. The method according to claim 15, wherein the non-visual sensor is a single-spectral electromagnetic sensor, a multi-spectral electromagnetic sensor, an acoustic sensor, a chemical sensor, or any combination thereof; and wherein the non-visual image comprises electromagnetic measurements (associated with one or more spectra other than the visual spectrum), acoustic measurements, chemical measurements, or any combination thereof, for each pixel;

17. The method according to claim 15, wherein the at least one neural network comprises an interpolation neural network that comprises a head for generating the synthetic visual image and comprises a head for generating the synthetic non-visual image; and wherein the interpolation neural network estimates depth data for each pixel in the input visual image.

18. The method according to claim 15, wherein the training set of visual data comprises 2D images derived from the visual sensor; 2D images obtained from a Computer-Assisted Design 3D model; a photogrammetry-derived 3D model; a LIDAR-point-cloud-derived 3D model; a 3D model derived from any combination of Computer-Assisted Design, photogrammetry, and a LIDAR point cloud; or any combination thereof; and wherein the training set of non-visual data comprises genuine 2D images derived from the non-visual sensor.

19. The method according to claim 15, wherein the training set of visual data and the training set of non-visual data are semantically segmented prior to training the at least one neural network, in order to establish ground truths that can be compared to an output of the at least one neural network such that weights applied by the at first at least one neural network can be adjusted.

20. The method according to claim 15, wherein the at least one neural network employs a Differentiable Sample Consensus (DSAC) algorithm; that is modified by the use of a parametric rectified linear unit (“PReLU”) activation function.

21. The method according to claim 15, wherein the at least one neural network comprises an interpolation neural network that comprises a neural radiance field, a predictive linear optimization algorithm, or a predictive non-linear optimization algorithm; and wherein the interpolation neural network is depth-supervised.

22. The method according to claim 15, wherein the training set of visual data and the inspection set of visual data are acquired by two or more visual sensors in the form of a stereo camera or a multi-lens camera.

23. The method according to claim 15, wherein an inverted neural radiance field is employed for refining the coarse poses.

24. The method according to claim 15, wherein the method further comprises removing, as an outlier, the synthetic visual image and/or the synthetic non-visual image respectively if the synthetic visual image differs from the input visual image by a threshold and/or the synthetic non-visual image differs from the input non-visual image by a threshold.

25. The method according to claim 15, wherein the method further comprises comparing time-lapse data by comparing:
the input visual image with a second input visual image from a second inspection set of visual data, wherein the second inspection set of visual data was acquired prior-in-time to the inspection set of visual data; and/or
the input non-visual image with a second input non-visual image from a second inspection set of non-visual data, wherein the second inspection set of non-visual data was acquired prior-in-time to the inspection set of non-visual data.

26. The method according to claim 15, wherein if the fine pose of the input visual image does not correspond to the fine pose of the second input visual image and/or the fine pose of the input non-visual image does not correspond to the fine pose of the second input non-visual image, and the method further comprises:
obtaining the fine pose of the input visual or non-visual image, or a fine pose of the second input visual or non-visual image;
generating, via the at least one neural network, from the fine pose of the input visual or non-visual image, or the fine pose of the second input visual or non-visual image, a synthetic image; and
comparing the synthetic image to the input image or the second input image, whichever is not associated with the fine pose with which the synthetic image was generated.

27. A non-transitory storage medium comprising computer-readable instructions for performing the method according to claim 1.

28. A non-transitory storage medium comprising computer-readable instructions for performing the method according to claim 15.

29. An inspection apparatus configured to perform the method according to claim 1, wherein the inspection apparatus comprises: a plurality of sensors including: at least one visual sensor, at least one location module, at least one anemometer, at least one open air optical path gas sensor, and at least one thermographic camera; one or more first processors; and at least one non-transitory storage medium comprising computer-readable instructions for execution by the one or more first processors.

30. An inspection apparatus configured to perform the method according to claim 15, wherein the inspection apparatus comprises: a plurality of sensors including: at least one visual sensor, at least one location module, at least one anemometer, at least one open air optical path gas sensor, and at least one thermographic camera; one or more first processors; and at least one non-transitory storage medium comprising computer-readable instructions for execution by the one or more first processors.

31. The inspection apparatus according to claim 29, further including a housing containing the plurality of sensors; and one or more grips extending from or formed in the housing.

32. The inspection apparatus according to claim 30, further including a housing containing the plurality of sensors; and one or more grips extending from or formed in the housing.
